(19) United States
(12) Patent Application Publication
(10) Pub. No.: US 2010/0110700 A1
(43) Pub. Date: May 6, 2010

(54) LIGHTING DEVICE

(76) Inventor: Chao-Chuan CHIEN, Taipei (TW)

Correspondence Address: RABIN & Berdo, PC, 1101 14TH STREET, NW, SUITE 500, WASHINGTON, DC, 20005, US

(21) Appl. No.: 12/265,872

(22) Filed: Nov. 6, 2008

(51) Int. Cl. F21V 19/02

(52) U.S. Cl. 362/372

(57) ABSTRACT

A lighting device is provided, which includes a handle, a lamp, and a swing arm. The swing arm is provided with a straight shaft and a horizontal shaft perpendicular to each other at two ends thereof. The horizontal shaft is disposed at a top end of the handle. The straight shaft is disposed on a rear surface of the lamp. The lamp is provided with a light source therein. The swing arm is capable of swinging back and forth relative to the handle and the lamp is capable of rotating back and forth relative to the swing arm, such that a swing angle and a rotation angle of the lamp is adjusted steplessly, which enables a user to adjust an illumination angle of light rays conveniently.

### BACKGROUND OF THE INVENTION

1. Field of the Invention

The present invention generally relates to a lighting device used in a handheld manner or being placed at a certain position, and more particularly to a housing structure of a lighting device provided with a special swing arm.

2. Related Art

Common lighting devices such as torch lights, camping lights, and working lamps can meet various illumination requirements depending upon different places. When it is intended to adjust an illumination angle of a lighting device, for example, as for a handheld torch light, the illumination angle of light rays is adjusted by adjusting an angle at which a user holds the torch light with a hand. In most cases, camping lights or working lamps are disposed in a suspended or magnetically attracted manner, which can avoid the inconvenience of holding with a hand and thus improve the convenience in usage.

Herein, a conventional working lamp is taken as an example. Referring to FIG. 1, a body 1 is provided with a light source 2 on a surface thereof. The body 1 is further provided with a hook 11 at a top end thereof for suspending the working lamp, and provided with a handle portion 12 at the other end thereof. The handle portion 12 is configured with a magnetic element 13 at a bottom thereof. The working lamp may be used in a suspending manner via the hook 11, or in a handheld manner, or placed on a magnetic-conductive metal surface. The working lamp is applicable to various places due to its diversified using modes. However, since the body I and the light source 2 are integrally designed, the illumination angle cannot be adjusted, and as a result, the illumination angle thereof is restricted in usage. Therefore, the conventional working lamp still has certain defects, which needs to be improved.

### SUMMARY OF THE INVENTION

Accordingly, the present invention is directed to a lighting device, which is capable of adjusting an illumination angle thereof among multiple angles, and thus suitable for being used in various places.

In order to achieve the above objective, a lighting device is provided in the present invention, which includes a handle, a lamp, and a swing arm. The handle is extended with a pair of lugs on a top end thereof, and each of the lugs is provided with a pivoting hole at a central portion thereof. The lamp includes a housing and a light source. The housing is provided with a pivoting hole thereon. The swing arm is provided with a straight shaft and a horizontal shaft perpendicular to each other at two ends thereof. During assembly, the horizontal shaft of the swing arm is disposed between the two lugs on the top end of the handle, and the straight shaft of the swing arm is disposed within the pivoting hole of the housing, so that a power line electrically connected to the light source passes through the swing arm.

Hence, in usage, since the swing arm is capable of uni-directionally adjusting its swing angle (swinging up and down) relative to the handle, and the lamp is capable of rotating (rotating left and right) relative to the swing arm, the illumination angle (including rotating and swing angles) of the lamp can be adjusted steplessly. Therefore, no matter the lighting device of the present invention is used in a handheld, suspended, or magnetically attracted manner, the user can adjust the illumination angle thereof, thereby greatly improving the convenience in usage.

### BRIEF DESCRIPTION OF THE DRAWINGS

The present invention will become more fully understood from the detailed description given herein below for illustration only, and thus is not limitative of the present invention, and wherein:

FIG. 1 is a stereogram of an appearance of a conventional working lamp;

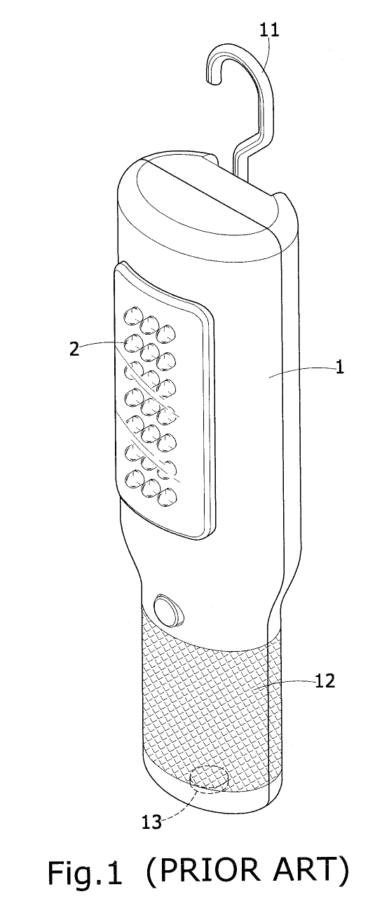

FIG. 2 is an exploded stereogram of a preferred embodiment of the present invention;

FIG. 3 is a combined stereogram of a preferred embodiment of the present invention;

FIG. 4 is a first schematic view of adjustment of an illumination angle according to a preferred embodiment of the present invention; and

FIG. 5 is a second schematic view of adjustment of an illumination angle according to a preferred embodiment of the present invention.

### DETAILED DESCRIPTION OF THE INVENTION

In order to make the content of the present invention more comprehensible, the embodiments of the present invention are described below with reference to the accompanying drawings.

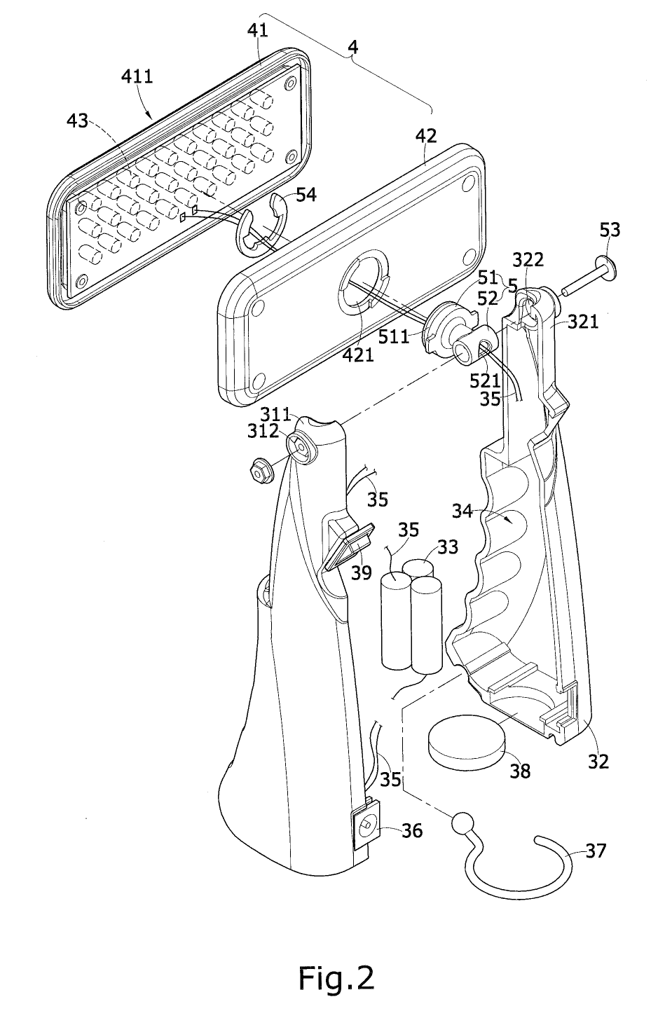

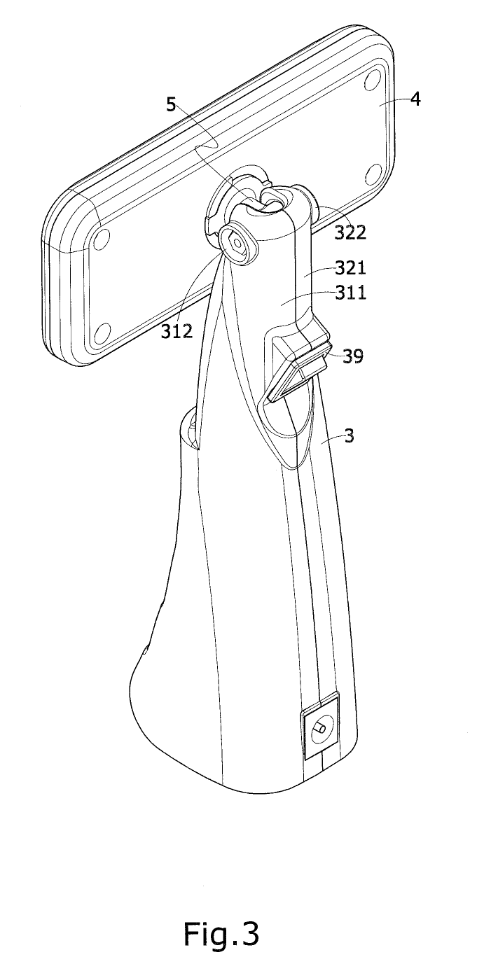

Referring to FIGS. 2-5, a lighting device of the present invention at least includes a handle 3, a lamp 4, and a hollow swing arm 5.

The handle 3 includes a left shell 31 and a right shell 32, which are respectively provided with a lug 311 and a lug 321 on top ends thereof. The left shell 31 and the right shell 32 can be engaged and fixed together into one piece. The lugs 311 and 321 are respectively provided with a pivoting hole 312 and a pivoting hole 322 at central portions thereof. The handle 3 is formed with an accommodation space 34 therein for accommodating a rechargeable battery 33. The rechargeable battery 33 is connected to a connection port 36 on a surface of the handle 3 via a power line 35. In addition, the rechargeable battery is electrically connected to the lamp. Moreover, the handle is provided with a switch 39 thereon. The switch 39 is electrically connected to the lamp 4 and the rechargeable battery 33. The handle 3 is configured with a rotatable hook 37 and a magnetic element 38 at a bottom thereof for being used in a suspended or attracted manner.

The lamp 4 is mainly formed by a front housing 41, a rear housing 42, and a light source 43 (an LED light source shown in the figure). The front housing 41 is provided with a light-transmissive window portion 411 at a central portion thereof. The rear housing 42 is provided with a pivoting hole 421 at a central portion thereof. The light source 43 is wrapped and disposed within the front housing 41 and the rear housing 42. Moreover, the light source 43 may also be an ordinary bulb (not shown) or a high-power Xenon bulb (not shown). Moreover, the pivoting hole 421 of the rear housing 42 is provided with a stopping portion (not marked in the figure) on an outer wall thereof. Correspondingly, the straight shaft of the swing arm is provided with a restricting portion thereon.

The hollow swing arm 5 is provided with a straight shaft 51 and a horizontal shaft 52 at two ends thereof, such that the straight shaft 51 and the horizontal shaft 52 are penetrated with each other. The horizontal shaft 52 of the swing arm 5 is disposed between the two lugs 311 and 321 on the top end of the handle 3. The horizontal shaft 52 of the swing arm 5 is provided with a fixing bolt 53 therein. Two ends of the fixing bolt 53 are respectively locked at an exterior of the pivoting holes 312 and 322 of the lugs 311 and 321, such that the swing arm 5 can swing back and forth with the pivoting holes 312 and 322 as pivot points. In addition, the horizontal shaft 52 of the swing arm 5 is provided with a line hole 521 at a central portion thereof. Moreover, the straight shaft 51 of the swing arm 5 is provided with an annular groove 511. Therefore, during assembly, the straight shaft 51 is fastened within the annular groove 511 by a fixing ring 54 after the straight shaft 51 passes through the pivoting hole 421 of the rear housing 42, so that the straight shaft 51 is engaged within the rear housing 42, thereby enabling the swing arm 5 to rotate within the rear housing 42 freely without dropping out. Moreover, the straight shaft 51 of the swing arm 5 is configured with a restricting portion (not marked in the figure) thereon, such that the rotating angle of the lamp 4 can be restricted by the stopping portion together with the restricting portion.

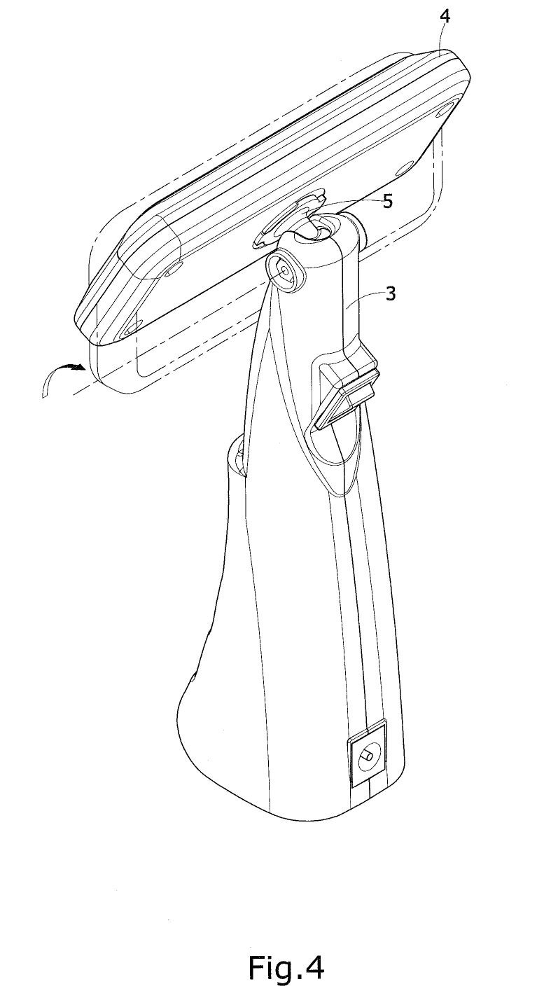

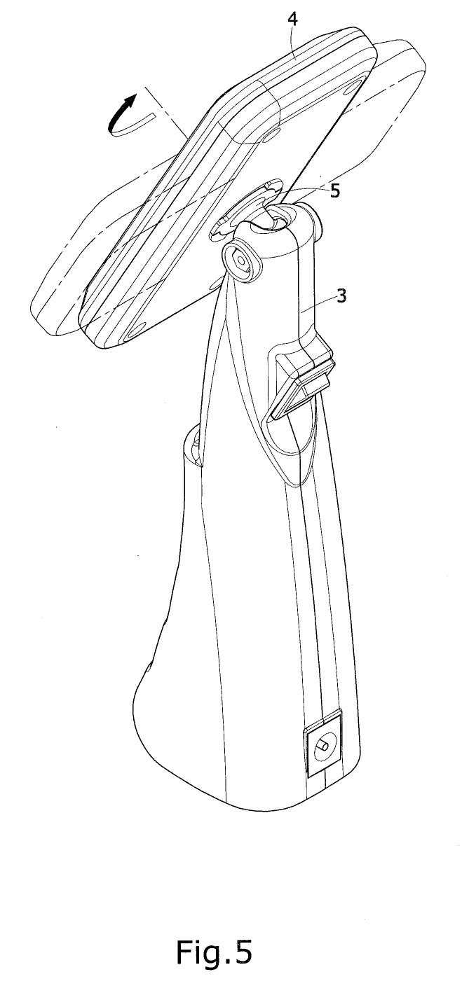

Since the swing arm S is disposed between the handle 3 and the lamp 4 in two axial directions that are perpendicular to each other, more than two different angle adjustment modes can be used. As such, when a user pushes the swing arm 5 up and down (as shown in FIG. 4), the swing arm 5 unidirectionally swings upwards or downwards relative to the pivoting positions of the handle 3, thereby adjusting an inclination angle of the illumination of the lamp 4. In addition, the user may also rotate the housing horizontally (as shown in FIG. 5) to make the lamp 4 unidirectionally rotate leftwards or rightwards relative to the swing arm 5, thereby adjusting a diffusion angle (rotation angle) of the illumination of the lamp 4. Moreover, the rotation of the lamp 4 relative to the swing arm 5 and the swinging motion of the swing arm 5 relative to the handle 3 can also be adjusted at the same time, so as to adjust the illumination angle of the lamp 4 among multiple angles. Therefore, no matter the lighting device of the present invention is used in a handheld, suspended, or magnetically attracted manner, the user can adjust the illumination angle freely, thereby greatly improving the convenience in usage.

To sum up, the present invention has the following advantages during implementation.

1. Referring to FIGS. 2-5, the swing arm 5 having two perpendicular axial directions is movably disposed between the handle 3 and the lamp 4 in the present invention, which facilitates the adjustment of the illumination angle.

2. Moreover, the handle 3 of the present invention is provided with a hook 37 at a bottom thereof, which allows the lighting device to be used in a suspended manner.

3. The handle 3 of the present invention is further configured with a magnetic element 38 at a bottom thereof, which allows the lighting device to be used in a manner of being attracted on a metal surface.

The above descriptions are merely preferred embodiments of the present invention, but not intend to limit the scope of the present invention. Other alternations such as types of the light source or materials of the swing arm all fall within the scope of the present invention. It will be apparent to those skilled in the art that various modifications and variations can be made to the structure of the present invention without departing from the scope or spirit of the present invention, such as modifying the lamp into an ordinary bulb or a high-power bulb.

In view of the above, the lighting device meets the patent requirement of inventive step and also has industrial applicability. Therefore, the applicant files for a patent according to the provisions of the Patent Act.

What is claimed is:

1. A lighting device, comprising:
a handle, provided with a pair of lugs on a top end thereof, wherein the pair of lugs is disposed opposite to each other, and each of the lugs is provided with a pivoting hole at a central portion thereof;
a lamp, comprising a housing and a light source, wherein the housing is provided with a pivoting hole thereon; and
a hollow swing arm, provided with a straight shaft and a horizontal shaft at two ends thereof, such that the straight shaft and the horizontal shaft are penetrating to each other, wherein the straight shaft is disposed within the pivoting hole of the housing, and the horizontal shaft of the swing arm is disposed between the two lugs on the top end of the handle.

2. The lighting device according to claim 1, wherein the handle is formed by engaging a left shell and a right shell together and provided with an accommodation space therein for accommodating a rechargeable battery, the rechargeable battery is connected to a connection port on a surface of the handle via a power line, and the rechargeable battery is electrically connected to the light source.

3. The lighting device according to claim 2, wherein the left shell and the right shell are respectively provided with a lug at top ends thereof and each of the lugs is provided with a pivoting hole.

4. The lighting device according to claim 2, wherein the handle is provided with a switch thereon and the switch is electrically connected to the light source and the rechargeable battery.

5. The lighting device according to claim 1, wherein the handle is provided with a hook at a bottom thereof.

6. The lighting device according to claim 1, wherein the handle is provided with a magnetic element at a bottom thereof.

7. The lighting device according to claim 1, wherein the horizontal shaft of the swing arm are penetrating at two ends thereof and provided with a line hole at a central portion thereof.

8. The lighting device according to claim 1, wherein the horizontal shaft of the swing arm is provided with a fixing bolt therein and two ends of the fixing bolt are locked at an exterior of the pivoting holes of the lugs.

9. The lighting device according to claim 1, wherein the straight shaft of the swing arm is provided with an annular groove and the straight shaft is fastened within the annular groove by a fixing ring after the straight shaft passes through the pivoting hole of the housing.

10. The lighting device according to claim 1, wherein the housing comprises a front housing and a rear housing, the front housing is provided with a light-transmissive window portion, and the rear housing is provided with a pivoting hole.

11. The lighting device according to claim 1, wherein the pivoting hole of the housing is provided with a stopping portion on an outer wall thereof, and correspondingly, the straight shaft of the swing arm is provided with a restricting portion thereon.
